(19) United States
(12) Patent Application Publication
(10) Pub. No.: US 2003/0144042 A1
(43) Pub. Date: Jul. 31, 2003

(54) Negotiation of position information during low battery life

(76) Inventors: Aaron Weinfield, Encinitas, CA (US); Patty Chang, San Diego, CA (US)

Correspondence Address: HARNESS, DICKEY & PIERCE, P.L.C., P.O. BOX 828, BLOOMFIELD HILLS, MI, 48303, US

(21) Appl. No.: 10/060,683

(22) Filed: Jan. 29, 2002

(51) Int. Cl. H04Q 7/20

(52) U.S. Cl. 455/574; 455/456

(57) ABSTRACT

The rate at which position information transmitted may be adjusted based upon the battery strength and whether the mobile station is operating in the emergency mode. The mobile station determines whether the battery is low, and transmits this information to the network. The mobile station may also transmit whether it is currently operating in an emergency mode. Based on this information, the network may adjust the rate at which the position information is reported from the mobile station.

### TECHNICAL FIELD

This invention relates to wireless communication systems, and more particularly to communication of position information based on available battery power.

### BACKGROUND

The use of wireless communication systems is growing with users now numbering well into the millions. One of the most popular wireless communications systems is the cellular telephone, consisting of a mobile station (or handset) and a base station. Cellular telephones allow a user to talk over the telephone without having to remain in a fixed location. This allows users to, for example, move freely about the community while talking on the phone. However, one inconvenience associated with routine use of a cellular telephone is the constant need to recharge and replace depleted batteries in the handset.

In some systems, the mobile station communicates the current position information back to the base station. The mobile station may report the position information upon request of the wireless network, or may be programmed to report the position information at a specific time interval or upon a particular change in position information. The mobile station consumes power each time the current position information is communicated to the base station. When the mobile station is operating under battery power, there may be circumstances that make it desirable to conserve power, thus increasing battery life. By controlling the interval at which the position information is reported, the battery life may be more effectively managed.

Improvements in battery technology, while helpful, have not avoided the seemingly ever-present need to recharge and replace mobile station batteries. The power required by the mobile station to transmit signals to the base station is one of the largest drains on battery power. In an attempt to extend battery life, mobile stations may be designed to limit the transmission of information to the base station. However, there is always a need to balance the transmission of information with the desire to conserve power. What is needed is a system to further conserve battery power by reducing the power consumed by the mobile unit.

### SUMMARY

The rate at which position information transmitted may be adjusted based upon the battery strength and/or whether the mobile station is operating in the emergency mode. The mobile station determines whether the battery is low, and transmits this information to the network. The mobile station may also transmit whether it is currently operating in an emergency mode. Based on this information, the network may adjust the rate at which the position information is reported from the mobile station.

### DESCRIPTION OF DRAWINGS

These and other features and advantages of the invention will become more apparent upon reading the following detailed description and upon reference to the accompanying drawings.

FIG. 1 illustrates the components of an exemplary wireless communication system used by one embodiment of the present invention.

FIG. 2 is a block diagram showing features of a mobile station according to one embodiment of the invention.

FIG. 3 is a flowchart illustrating a process for communicating the state of the battery and emergency status of the mobile station according to one embodiment of the invention.

FIG. 4 is a flowchart illustrating a process for adjusting the rate of position reports from the mobile station according to one embodiment of the invention.

### DETAILED DESCRIPTION

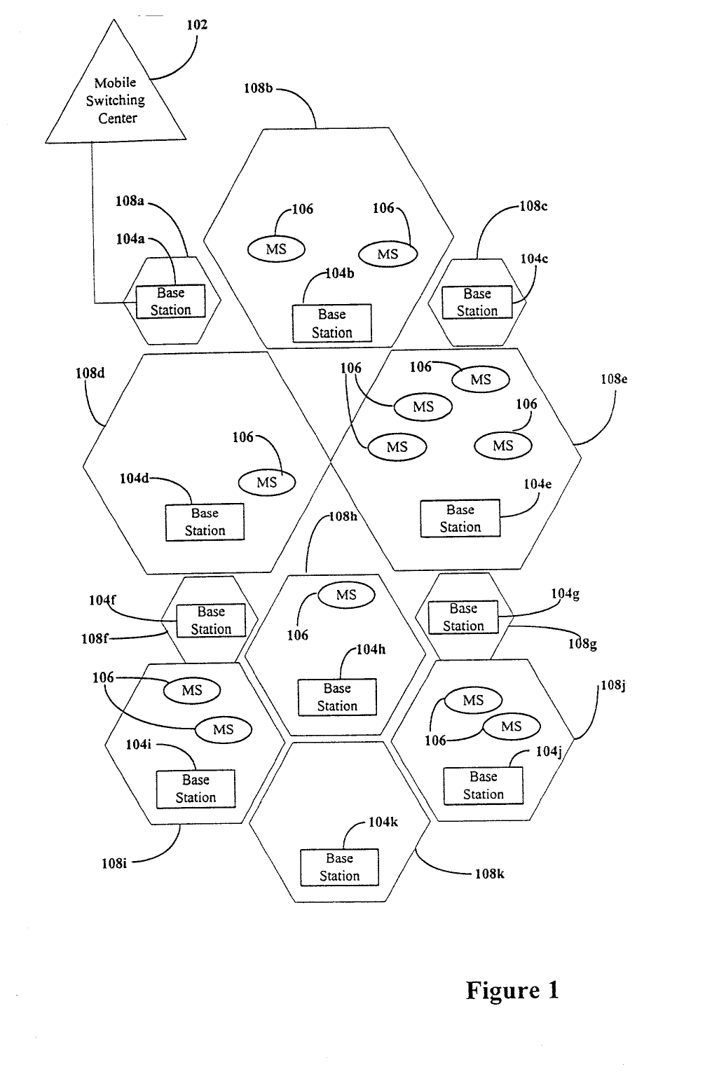

FIG. 1 illustrates components of an exemplary wireless communication system 100. A mobile switching center 102 communicates with base stations 104a-104k (only one connection shown). The base stations 104a-104k (generally 104) broadcasts data to and receives data from mobile stations 106 within cells 108a-108k (generally 108). The cell 108 is a geographic region, roughly hexagonal, having a radius of up to 35 kilometers or possibly more.

A mobile station 106 is capable of receiving data from and transmitting data to a base station 104. In one embodiment, the mobile station 106 receives and transmits data according to the Code Division Multiple Access (CDMA) standard. CDMA is a communication standard permitting mobile users of wireless communication devices to exchange data over a telephone system wherein radio signals carry data to and from the wireless devices.

Under the CDMA standard, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

When detecting a call, the cellular telephone scans data frames broadcast by the base station 104 to detect any telephone calls or paging messages directed to the cellular telephone. In this call detection mode, the cellular telephone receives, stores and examines paging message data, and determines whether the data contains a mobile station identifier matching an identifier of the cellular telephone. If a match is detected, the cellular telephone establishes a call with the mobile switching center 102 via the base station 104. If no match is detected, the cellular telephone enters an idle state for a predetermined period of time, then exits the idle state to receive another transmission of paging message data.

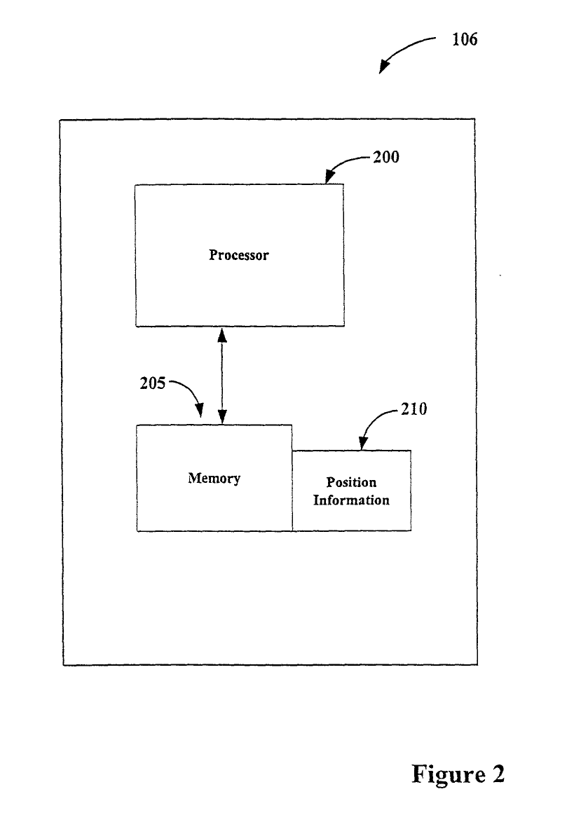

FIG. 2 shows a block diagram of the mobile station 106 and the processing that occurs in that mobile station 106. The processor 200 is driven by a program stored in a memory 205.

The mobile station 106 may obtain information regarding the current position of the mobile station 106. This information may be obtained from a variety of sources, including global positioning, triangulation between base stations, internal calculations or any other method. A memory 210 may store various conditions including the current position information.

The mobile station 106 currently reports position information based upon network requests. The network is requesting these position reports without any regard to the status of the mobile status 106. Power is consumed each time a position report is transmitted. Thus, a mobile station 106 with a weak battery constantly reporting the position may cause the battery to fail, thus making the mobile station 106 unusable. As the network is unaware of the status of the battery in the mobile station 106, no change in the time interval between position report requests are typically made.

There are also other factors in which it would be advantageous to adjust the rate at which the mobile station 106 reports the current position. For example, if the mobile station 106 is in an emergency mode, it may be desirable to increase the rate of position information. However, the network currently does not have any method of determining the status of the mobile station 106, and consequently, adjusting the rate of position reporting based on that status.

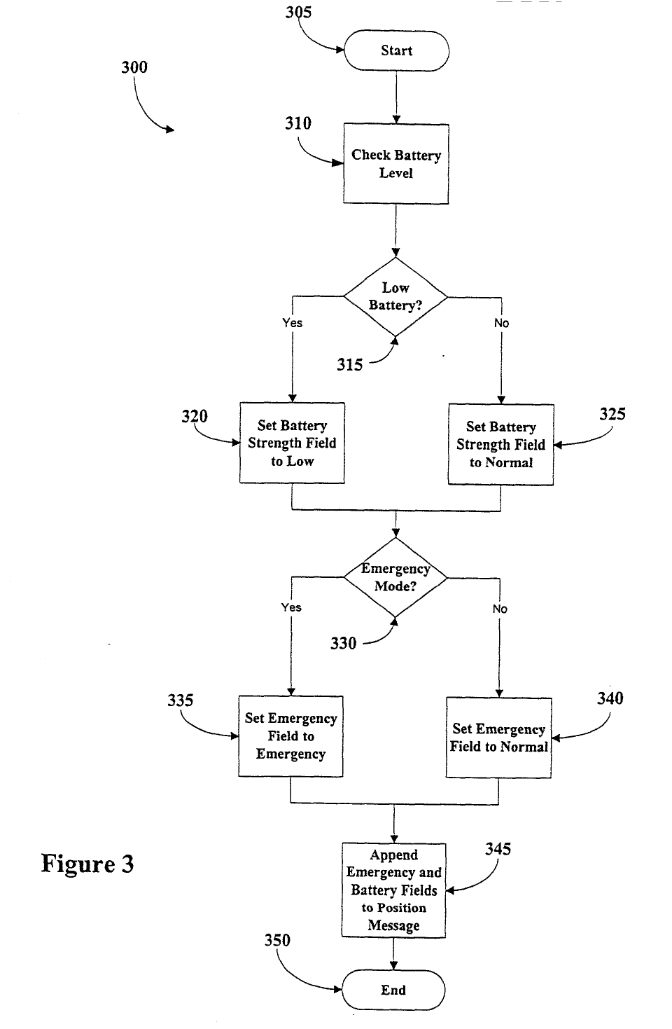

FIG. 3 is a flowchart illustrating a process 300 for communicating the state of the battery and emergency status of the mobile station 106. The process 300 begins at a start block 305. Proceeding to block 310, the process 300 checks the battery level of the mobile station 106. The battery level of the mobile station 106 may be determined using a variety of methods that are known in the art. Proceeding to block 315, the mobile station 106 determines whether the battery level is low. A predetermined threshold may have been set within the mobile station 106 to define when the battery level is considered low. The threshold may be defined in the initial programming of the mobile station 106, or may be a user defined field.

If the battery strength is below the threshold, the process 300 proceeds along the YES branch to block 320. In block 320, the mobile station 106 sets a battery strength field to high to indicate the battery is weak. For example, an additional bit field may be created to indicate battery strength. When the battery bit field is set to “0”, the battery strength is considered normal. When the battery bit field is set to “1”, the battery strength is considered low. Thus, in block 320 the mobile station 106 sets the battery bit field to “1” indicating the battery is in a low state.

Returning to block 315, if the battery strength is above the threshold, the process 300 proceeds along the NO branch to block 325. In block 325, the mobile station 106 sets the battery strength field to low to indicate the battery is strong. For example, the mobile station 106 may set the battery bit field to “0” indicating the battery is in a normally charged state. Of course, if the mobile station is being powered off an external device such as a car kit, the battery strength should not be a factor. In this circumstance, the mobile station 106 may also set the battery strength field to normal.

Proceeding to block 330, the process 300 determines whether the mobile station 106 is operating in the emergency mode. The mobile station 106 may operate in a emergency mode if an emergency call (such as 911) is placed or other factor places the mobile station 106 in the emergency mode. In the emergency mode, the mobile station 106 may remain on a single channel to decrease the possibility of dropping the call.

If the mobile station is in the emergency mode, the process 300 proceeds along the YES branch to block 335. In block 335, the mobile station 106 sets an emergency field to high to indicate the mobile station is operating in the emergency mode. For example, an additional bit field may be created to indicate emergency mode status. When the emergency bit field is set to “0”, the mobile station 106 is operating normally. When the emergency bit field is set to “1”, the mobile station 106 is operating in the emergency mode. Thus, in block 335 the mobile station 106 sets the emergency bit field to “1” indicating the mobile station 106 is operating in the emergency mode.

Returning to block 330, if the mobile station 106 is not operating in the emergency mode, the process 300 proceeds along the NO branch to block 340. In block 340, the mobile station 106 sets the emergency field to low to indicate the mobile station 106 is operating normally. For example, the mobile station 106 may set the emergency bit field to “0”.

Proceeding to block 345, the mobile station 106 appends the emergency bit field and the battery strength bit field to the position message. The position message may be redefined to include two additional bits, representing the emergency bit field and the battery strength bit field. Thus, whenever the mobile station 106 reports its present position to the network, the status of the battery strength and emergency status are also reported. The process 300 then terminates in an END block 350.

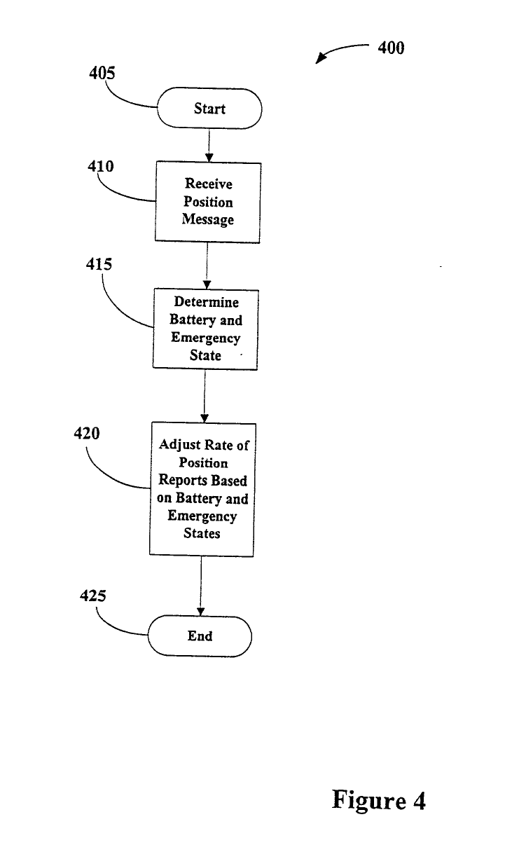

FIG. 4 is a flowchart illustrating a process 400 for adjusting the rate of position reports from the mobile station 106. The process 400 begins in a START block 405. Proceeding to block 410, the network receives the position message from the mobile station 106. The position message is appended with the battery strength and emergency state bit fields as described above.

Proceeding to block 415, the network decodes the position message to determine the current battery state of the mobile station 106 and the current emergency state of the mobile station 106. For example, when the battery strength and emergency state bits in the position message are “01”, the network may determine the mobile station 106 is operating in the emergency mode and has a normal battery strength. When the battery strength and emergency state bits in the position message are “10”, the network may determine the mobile station 106 is not operating in the emergency mode and has low battery power. When the battery strength and emergency state bits in the position message are “00”, the network may determine the mobile station 106 is not operating in the emergency mode and has a normal battery strength. When the battery strength and emergency state bits in the position message are “11”, the network may determine the mobile station 106 is operating in the emergency mode and has a weak battery.

Proceeding to block 420, the process 400 may then adjust the rate of the position reports based on the battery strength and emergency status of the mobile station 106. The is rate may be reduced, for example, when the mobile station 106 has low battery power to prevent the battery from being prematurely depleted. However, the rate may be increased when the mobile station 106 is in an emergency mode so that the position of the mobile station 106 may be updated and communicated to rescue personnel. When the mobile station 106 is in the emergency mode and has a low battery, a decision needs to be made on whether it is more important to report an accurate position or to conserve battery power. This decision may be made using a variety of factors, such as whether the mobile station 106 is changing positions. The decision may be made by an algorithm weighing a plurality of factors, or may be pre-selected by the user upon setup. The mobile station 106 may also submit a recommendation to the network based on the current rate of reporting the position information. Thus, the mobile station 106 may negotiate a proper rate depending on the status of the battery power and emergency state.

Numerous variations and modifications of the invention will become readily apparent to those skilled in the art. Accordingly, the invention may be embodied in other specific forms without departing from its spirit or essential characteristics.

What is claimed is:

1. A method of reporting position information in a wireless information system comprising:
checking a battery level of a mobile station;
comparing the battery level is to a threshold; and
adjusting the rate of position information reports based on comparison between the battery level and the threshold.

2. The method of claim 1, further comprising:
determining whether the mobile station is operating in an emergency mode; and
adjusting the rate of position information reports based on operation in emergency mode.

3. The method of claim 1, further comprising communicating the comparison between the battery level and the threshold to the network.

4. The method of claim 2, further comprising communicating the emergency mode status to the network.

5. The method of claim 3, further comprising receiving an adjusted position information rate from the network.

6. The method of claim 1, further comprising appending the comparison between the battery level and the threshold to a position report.

7. The method of claim 1, further comprising reducing the rate of position information reports when the battery level is below the threshold.

8. A method of reporting position information in a wireless information system comprising:
checking a battery level of a mobile station;
comparing the battery level is to a threshold;
determining whether the mobile station is operating in emergency mode; and
adjusting the rate of position information reports based on comparison between the battery level and the threshold and operation in emergency mode.

9. The method of claim 8, further comprising communicating the comparison between the battery level and the threshold and the emergency mode status to the network.

10. The method of claim 9, further comprising receiving an adjusted position information rate from the network.

11. The method of claim 1, further comprising appending the comparison between the battery level and the threshold and the emergency mode to a position report.

12. A method of reporting position information in a wireless information system comprising:
determining whether the mobile station is operating in an emergency mode; and
adjusting the rate of position information reports based on operation in emergency mode.

13. The method of claim 12, further comprising:
checking a battery level of a mobile station;
comparing the battery level is to a threshold; and
adjusting the rate of position information reports based on comparison between the battery level and the threshold.

14. The method of claim 12, further comprising communicating the emergency mode status to the network.

15. The method of claim 13, further comprising communicating the comparison between the battery level and the threshold to the network.

16. The method of claim 14, further comprising receiving an adjusted position information rate from the network.

17. The method of claim 12, further comprising appending the emergency mode status to a position report.

18. The method of claim 12, further comprising increasing the rate of position information reports when the mobile station is in the emergency mode.
